(19) United States
(12) Patent Application Publication
(10) Pub. No.: US 2011/0132382 A1
(43) Pub. Date: Jun. 9, 2011

(54) CIGARETTE PAPER COATED WITH COATING MATERIALS FOR LOW IGNITION PROPENSITY AND A FIRE-SAFE CIGARETTE COVERED BY THE SAME

(75) Inventors: Jong Yeol Kim, Daejon (KR); Soo Ho Kim, Cheongju-si (KR); Jin Won Park, Daejon (KR); Yong Joo Sung, Daejon (KR); Burm Ho Yang, Daejon (KR); Moon Yong Lee, Daejon (KR); Chung Ryul Kim, Daejon (KR); Jae Jin Kwang, Daejon (KR); Moon Soo Rhee, Daejon (KR)

(73) Assignee: KT&G CORPORATION, Daejeon (KR)

(21) Appl. No.: 13/001,210

(22) PCT Filed: Jun. 25, 2009
(86) PCT No.: PCT/KR2009/003425

§ 371 Date: Feb. 22, 2011

(30) Foreign Application Priority Data
Jun. 26, 2008 (KR) 10-2008-0060828

(51) Int. Cl. A24D 1/02; B32B 21/04

(52) U.S. Cl. 131/365; 428/211.1; 428/533; 428/486; 428/537.5

(57) ABSTRACT

The present invention relates to a cigarette paper with a coating material for Low Ignition Propensity (LIP) and a fire-safe cigarette having the same. More particularly, the present invention manufacture a cigarette paper by coating a pre-determined area with a coating material for LIP to lower a porosity of the cigarette paper, and relates to a cigarette paper which retains original flavor and taste of the cigarette and has an improved fire-safety and a cigarette having the same. The present invention provides a cigarette paper containing a coating material for LIP having an improved quality as compared to a conventional composition applicable to a fire-safe cigarette and thus capable of retaining the original flavor of the cigarette as well as having ash integrity, and cigarette having the same.

### TECHNICAL FIELD

The present invention relates to a cigarette paper coated with a Low Ignition Propensity (LIP) and a fire-safe cigarette having the same.

More particularly, the present invention relates to a cigarette paper which is naturally extinguished upon non-smoking, exhibits original flavor of a cigarette upon smoking as well as acquires an improved evaluation in the coated portion in a test for testing ash integrity, char line, ash color and staining by coating on a predetermined width of the cigarette paper with a coating material for Low Ignition Propensity (LIP), a fire-safe cigarette having the same.

### BACKGROUND ART

In general, a cigarette includes a cigarette paper (cut tobacco part) for surrounding tobaccos, a filter (filter part) and a tip paper for connecting the filter part with the cut tobacco part.

Conventionally, in order to manufacture a fire-safe cigarette, a cigarette paper is manufactured so that a coating material for Low Ignition Propensity (LIP) is included in the cigarette paper in a form of a band and thus a cigarette has a low porosity which induces the cigarette to be naturally extinguished upon non-smoking, and a cigarette product is manufactured using this cigarette paper.

However, most of the cigarettes containing the free coating material for Low Ignition Propensity (LIP) exhibit off-notes in a flavor item of a sensory test, which lowers a original taste of the cigarette.

For example, Korean Patent Laid Open Publication No. 2007-0104598 and U.S. Pat. No. 6,904,917 disclose a cigarette paper containing sodium alginate as a coating material for Low Ignition Propensity (LIP), but the use of the sodium alginate exhibits an off-notes which lowers the original taste of the cigarette.

Also, most of the cigarettes containing the coating material for LIP acquire an inadequate evaluation in an ash integrity test since burned ashes are more scattered, staining of the cigarette paper becomes worse and the char line is more crooked as compared to a conventional non-banded cigarette paper.

### DISCLOSURE OF INVENTION

### Technical Problem

An object of the present invention is to provide a cigarette paper coated with a coating material for Low Ignition Propensity (LIP), which allows a cigarette to be automatically extinguished upon non-smoking and to retain a original taste of the cigarette upon smoking, and a fire-safe cigarette having the same.

More particularly, by coating a coating material for Low Ignition Propensity (LIP) on a predetermined width of a cigarette paper, a balance among heat source, oxygen and fuel is destroyed when a burn region reaches to the band and the cigarette is thus automatically extinguished.

Also, the present invention relates to a cigarette paper coated with a coating material for LIP which does not exhibits off-notes of a cigarette before and after smoking and has no change of a taste of the cigarette by coating a free coating material for LIP thereon, and a fire-safe cigarette having the same.

Also, the present invention relates to a cigarette paper coated with a coating material for LIP which has acquired, in an external appearance, an improved evaluation in a sensory test for ash integrity. ash color and staining by thermal deformation when a burning region reached to a coated portion of the cigarette paper during smoking.

Another object of the present invention is to provide a cigarette having no change of a original flavor thereof and no concern of staining by the thermal deformation in the cigarette having the cigarette paper.

### Technical Solution

To achieve the above objects, the present invention provides a cigarette paper coated with a coating material for Low Ignition Propensity (LIP) which maintains an automatic extinguishment effect and a original taste of the cigarette, and a fire-safe cigarette having the same.

Hereinafter, a preferred embodiment of the present invention will be described in detail with reference to FIG. 1.

The present invention relates to a cigarette paper coated with a coating material for Low Ignition Propensity (LIP) containing one selected from the group consisting of diutan gum, darmar gum, gellan gum, sorbitan monostearate, sorbitan isosterate, propylene glycol stearate, glyceryl stearate, stearyl alcohol and Alpha-tocopheryl acetate, or a mixture thereof, and a fire-safe cigarette having the same.

More preferably, the coating material for LIP contains at least one selected from the group consisting of darmar gum, gellan gum and sorbitan monostearate.

Also, a mixture of darmar gum, gellan gum and sorbitan monostearate can be used as the coating material for LIP and the mixing ratio of the darmar gum:gellan gum:sorbitan monostearate is suitably 1:0.1˜1.5:0.1˜1.5, but not largely limited thereto.

The darmar gum, gellan gum and sorbitan monostearate have a similar pyrolysis pattern to a cigarette paper not coated with the coating material for LIP, and therefore allow the cigarette to retain its original taste. Also, the diutan gum is known to have excellent flame retardancy, and the gellan gum is known to have excellent heat resistance, acid resistance and enzyme resistance.

The stearyl alcohol or the alpha-tocopheryl acetate allows more effective automatic extinguishment upon non-smoking since it has an excellent viscosity and prevents oxygen from passing therethrough while being melted.

The coating material for Low Ignition Propensity (LIP) is coated with a predetermined width spacing on an outside, an inside or both sides of the cigarette paper.

The coating material for LIP can be used by being dissolved in water or an organic solvent such as alcohols and benzene and at this time 1˜50 parts of weight of the coating material for LIP can be dissolved based on the 100 parts on the weight of the water or the organic solvent and used.

Here, the coating material for LIP is formed, though not largely limited to, in a form of a band having a width of 4˜20 mm, preferably 5˜15 mm. The width of less than 4 mm lowers the effect of the automatic extinguishment and the width of more than 20 mm can exhibit off-notes and thus reduce the original taste of the cigarette.

Also, the coating material for Low Ignition Propensity (LIP) is formed, though not limited to, in a form of a plurality of bands (1 and 2 of FIG. 1) spaced apart from each other by a spacing of 4˜40 mm, preferably 5˜30 mm. The aforementioned range of spacing is suitable since the spacing should not be such large that the cigarette can burn for a time enough for the cigarette paper to ignite the other material and the original taste of the cigarette can be retained upon smoking.

To coat the bands in a spaced form, films are adhered onto the rest portions except for the portions to be coated with the coating material for LIP with the predetermined space so that the coating material for LIP is not applied on the rest portions. Any film can be used provided that it does not transmit the coating material for LIP, and examples for the film include polypropylene (BG, Filmax), polyester (Skyrol SG, SKC) and polyimide (IN70, SKC). Also, the used film is removed after the coating and dry.

The coating material for LIP is formed in the form of a band at a portion of the cut tobacco part (4 of FIG. 1) at a distance of 5˜20 mm from the tip of the filter part (3 of FIG. 1), and it is possible to maintain the original taste of the cigarette and make the smoking easy upon smoking within the aforementioned range.

Further, the present invention provides a cigarette paper coated with a coating material for Low Ignition Propensity (LIP) having a thickness of 0.5˜20 μm, preferably 2˜15 μm, and it is possible, within the aforementioned range, to obtain the automatic extinguishment effect and retain the original taste of the cigarette upon smoking.

Furthermore, the coating material for LIP is coated by 0.001˜1 g per unit area(cm²) of the cigarette paper, and the automatic extinguishment effect can be obtained within the aforementioned range.

Manufacture of the cigarette containing the cigarette paper coated with the coating material for LIP is performed by putting tobaccos into a RYO (Roll Your Own, OCB, German Y) and then making a rolled tobacco .by rotation with the cigarette paper being laid on the cigarette rolling machine, and a series of filterless cigarettes is manufactured through the aforementioned processes. After that, the manufacture of the cigarette is completed by connecting a filter and the rolled tobacco using a non-perforated tip paper.

### Advantageous Effects

A fire-safe cigarette having the cigarette paper coated with the coating material for Low Ignition Propensity (LIP) has advantages that it is automatically extinguished during non-smoking, does not exhibit off-notes before and after smoking and also exhibits no change of taste during the smoking. Further, there is an effect of acquiring an improved evaluation in a sensory test for the ash integrity when a burning region reaches to the coated portion of the cigarette paper during the smoking.

### BRIEF DESCRIPTION OF DRAWINGS

The above and other objects, features and advantages of the present invention will become apparent from the following description of preferred embodiments given in conjunction with the accompanying drawings, in which:

FIG. 1 is a view illustrating a cigarette containing a cigarette paper coated with a coating material for Low Ignition Propensity (LIP) in a form of bands with a predetermined space according to an embodiment of the present invention;

FIG. 2 is a graph showing analyses of pyrolysis pattern and products of the cigarette papers manufactured in Examples 1 to 5 and Comparative examples 1 and 2;

FIG. 3 shows the results of analysis of smoke components (tar and nicotine) in the mainstream smoke of the cigarettes manufactured in Examples 1 to 5 and Comparative Examples 1 and 2 and a puff number;

FIG. 4 shows the results of a Quantitative descriptive analysis (paired t-test) on a sensory test for the taste of the cigarettes manufactured in Example 1 to 5 and Comparative Example 1; and

FIG. 5 shows results of analysis of a sensory test for the ash integrity of the cigarettes manufactured in Example 1 to 5 and Comparative Example 1.

### DESCRIPTION OF MAIN ELEMENTS

1: general cigarette paper
2: band coated with coating material for LIP according to the present invention
3: filter part
4: cut tobacco part

### MODE FOR THE INVENTION

Hereinafter, the present invention will be described in detail with reference to examples. However, the following examples illustrate the present invention, by way of example only and the contents of the present invention are not limited to the following examples.

### Example 1

### Manufacture of Cigarette Paper Coated with Coating Material for Low Ignition Propensity (LIP)

A cigarette paper was manufactured as follows using diutan gum as a coating material for LIP.

The cigarette paper according to the present invention was manufactured by coating a conventional cigarette paper with a coating material for LIP, and the coating process was performed as follows.

(1) A conventional cigarette paper was adhered to an A4 paper and films were adhered on rest portions of the cigarette paper except for the portions with a predetermined space to be coated with the coating material for LIP,

(2) 1 g of diutan gum was dissolved in 50 ml of water, and

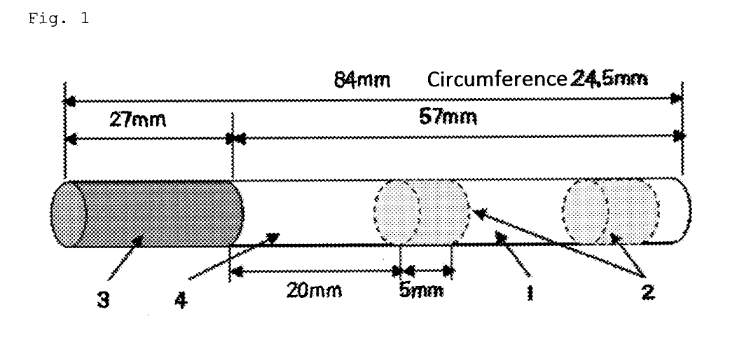

(3) about 3 ml of the dissolved solution was put on the A4 paper, followed by coating with a width of 5 mm and a thickness of 11 μm (wire bar No. 5) using a coater (Gist, model: GBC-A4) (1 and 2 of FIG. 1), drying and removing the film, thereby preparing the cigarette paper.

Manufacture of Cigarette Having the Cigarette Paper

Manufacture of the cigarette containing the cigarette paper was performed by putting 590 mg of cut tobaccos (T brand) into a cigarette rolling machine (RYO: Roll Your Own, OCB, Germany) and then making a rolled tobacco by rotation with the cigarette paper being laid on the cigarette rolling machine, and a series of filterless cigarettes was manufactured through the aforementioned processes. After that, a filter (Dongyang, T filter) and the rolled tobacco were connected using a non-perforated tip paper, thereby completing the manufacture of the cigarette. The cigarette was conditioned for more than 48 hours under ISO 3402 before the test.

At that time, the cigarette was manufactured so that two coated bands are formed at the cut tobacco part 4 at a distance of 20 mm from the filter part 3.

Specifications of the manufactured cigarette are shown in Table 1.

### Example 2

### Manufacture of Cigarette Paper Coated with Coating Material for Low Ignition Propensity (LIP)

A cigarette paper was manufactured by the same method as in Example 1 except that 1 g of gellan gum was used as a coating material for Low Ignition Propensity (LIP).

Manufacture of Cigarette Having the Cigarette Paper

A cigarette was manufactured with the manufactured cigarette paper by the same method as in Example 1.

Specifications of the manufactured cigarette are shown in Table 1.

### Example 3

### Manufacture of Cigarette Paper Coated with Coating Material for Low Ignition Propensity (LIP)

A cigarette paper was manufactured by the same method as in Example 1 except that 1 g of sorbitan monostearate was used as a coating material for LIP.

Manufacture of Cigarette Having the Cigarette Paper

A cigarette was manufactured with the manufactured cigarette paper by the same method as in Example 1.

Specifications of the manufactured cigarette are shown in Table 1.

### Example 4

### Manufacture of Cigarette Paper Coated with Coating Material for Low Ignition Propensity (LIP)

A cigarette paper was manufactured by the same method as in Example 1 except that 1 g of darmer gum was used as a coating material for LIP.

Manufacture of Cigarette Having the Cigarette Paper

A cigarette was manufactured with the manufactured cigarette paper by the same method as in Example 1.

Specifications of the manufactured cigarette are shown in Table 1.

### Example 5

### Manufacture of Cigarette Paper Coated with Coating Material for Low Ignition Propensity (LIP)

A cigarette paper was manufactured by the same method as in Example 1 except that 0.5 g of sorbitan monostearate and 0.5 g of gellan gum were used as a coating material for LIP.

Manufacture of Cigarette Having the Cigarette Paper

A cigarette was manufactured with the manufactured cigarette paper by the same method as in Example 1.

Specifications of the manufactured cigarette are shown in Table 1.

### Comparative Example 1

### Manufacture of Cigarette Paper Coated with Coating Material for Low Ignition Propensity (LIP)

A cigarette paper was manufactured by the same method as in Example 1 except that 1 g of sodium alginate (which is used in a commercial fire-safe cigarette paper) was used as a coating material for LIP.

Manufacture of Cigarette Having the Cigarette Paper

A cigarette was manufactured with the manufactured cigarette paper by the same method as in Example 1.

Specifications of the manufactured cigarette are shown in Table 1.

### Comparative Example 2

A general cigarette paper was not coated with a coating material for Low Ignition Propensity (LIP).

Manufacture of Cigarette Having the Cigarette Paper

A cigarette was manufactured with the general cigarette paper by the same method as in Example 1.

Specifications of the manufactured cigarette are shown in Table 1.

Physical properties of the manufactured cigarette papers and the cigarette having the cigarette papers were tested through Experimental Examples 1 to 5.

### Experimental Example 1

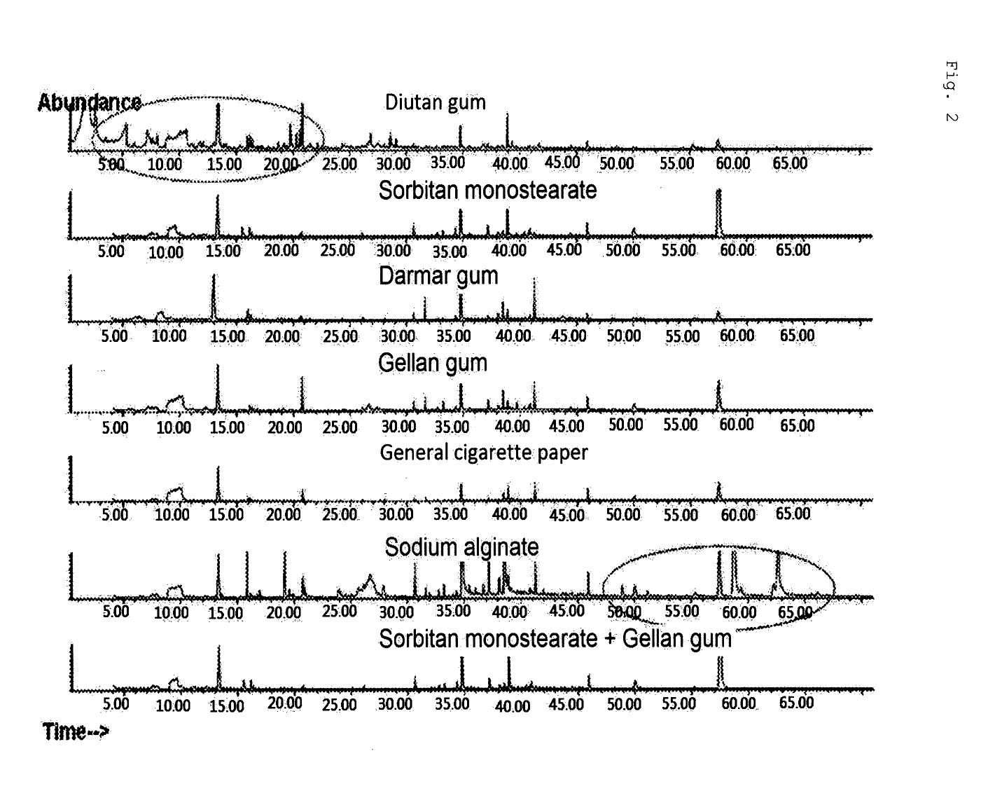

Pyrolysis pattern and products were analyzed using the cigarette papers manufactured in Examples 1 to 5 and Comparative examples 1 and 2, and the results are shown in FIG. 2.

The pyrolysis pattern was analyzed using a pyrolizer under the following condition.
Analyzer: Pyolyzer 2020iD-GC (6890)/MS (5973)
Analysis Condition: Column: DB5-MS (30 m×0.25 mm×0.25 um)
   Column Temp.:

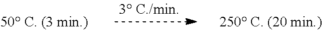

Pyrolyzer Temp.:

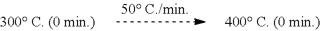

Split Ratio: 100:1
Scan Mode

As shown in FIG. 2, the results showed that the pyrolysis pattern of the conventional cigarette paper or Comparative Example 2, which is not coated, and the cigarette papers having a band applied with sorbitan monostearate, darmar gum and gellan gum, respectively, are similar to one another. On the contrary, the results showed that the pyrolysis pattern of the conventional cigarette paper which is not coated and the pyrolysis patterns of the cigarette papers coated with the coating material for LIP containing diutan gum and sodium alginate (which is used in a commercial fire-safe cigarette paper) respectively are different.

Therefore, the analysis showed that it is possible to manufacture a fire-safe cigarette having no difference in the taste of the cigarette compare to a general cigarette when the cigarette paper is manufactured using sorbitan monostearate, darmer gum or gellan gum which show similar pyrolysis pattern to a conventional cigarette paper.

### Experimental Example 2

Burning intensities were measured by a standard technique for measuring a burning intensity of a fire-safe cigarette, which is developed by National Institute of Standards and Technology (NIST), established by ASTM2187-04 and employed by the government of New York state (USA) and Canadian government, using the cigarettes manufactured in Examples 1 to 4 and Comparative Examples 1 and 2, and the results are shown in Table 2.

The test is for testing possibility whether a cigarette laid on ten sheets of filter papers can continuously burn and generate heat for fire, and is repeated 40 times by products. The tested product can be certified as a fire-safe cigarette when a ratio of the completely burned cigarette is less than 25% (more than 75% of natural extinguishment).

Further, a product of which cigarette paper is coated with a coating material for Low Ignition Propensity (LIP) should meet that two or more identical bands are present in the cigarette and at least one band is present at a position at a distance of more than 15 mm from an end of the cigarette.

The test was repeated 20 times with the cigarettes manufactured in Examples 1 to 5 and Comparative Example 1.

As shown in Table 2, the results showed that the cigarettes containing the cigarette papers manufactured in Examples 1 to 5 of the present invention have superior burning intensity to the cigarette manufactured in Comparative Example 1 and the diutan gum is the most superior among the coating material for LIPs of the present invention.

Although the analysis showed that the ratio of the completely burned cigarettes is not less than 25%, this is estimated that the coating material for LIP is not coated by a precise manufacture process but coated in laboratory scale. And, since a fir-safe cigarette employing sodium alginate or Comparative Example 1 is currently sold, it was estimated that apply of the coating material for LIP would be able to meet the standard of the fire-safe cigarette.

### Experimental Example 3

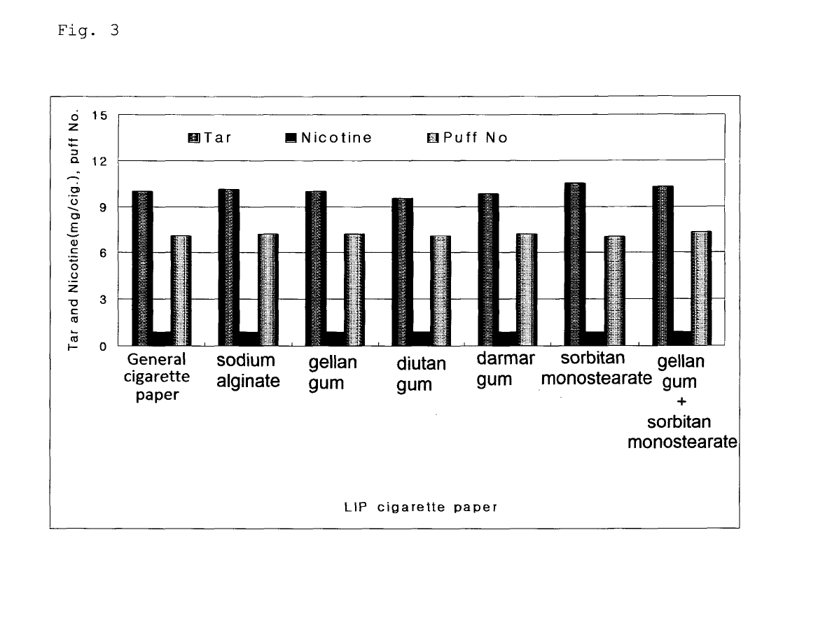

Amount of smoke components (tar and nicotine) in the mainstream smoke of the cigarettes manufactured in Examples 1 to 5 and Comparative Examples 1 and 2 and a puff number were measured and the results are shown in FIG. 3.

As shown in the result of FIG. 3, the analysis showed that the amounts of the tar and nicotine are equal in all the cigarettes manufactured in Examples 1 to 5 and Comparative Examples 1 and 2. Therefore, the cigarette containing the cigarette paper coated with the coating material for LIP of the present invention was analyzed to be the cigarette which meets tasting needs of smoker.

### Experimental Example 4

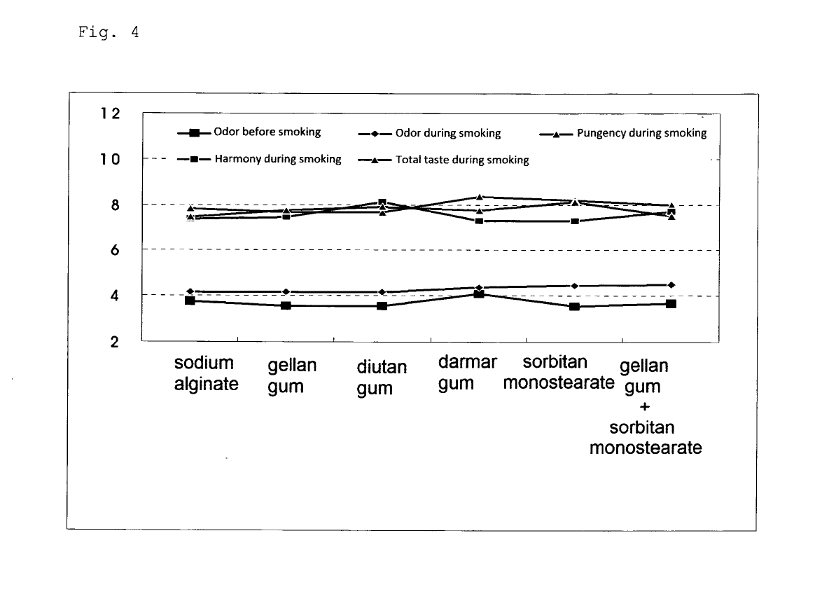

A smoking sensory test was performed on 5 items (off-notes before smoking, offnotes during smoking, pungency during smoking, harmonized taste during smoking and total taste during smoking) with 15 point scale with respect to the cigarettes manufactured in Example 1 to 5 and Comparative Example 1 by 25 special sensory test personnel and Quantitative descriptive analysis (paired t-test) was then performed. The results are shown in FIG. 4.

The test was performed on the basis of items which have an influence on smokers' preference when the smokers select cigarette.

Off-notes before smoking: this means a property which should not be present in original taste or flavor of the cigarette before smoking and a factor which lowers the value of the product, and the stronger off-notes is directed to 15 point.

Off-notes during smoking: this means a property which should not be present in original taste or flavor of the cigarette before smoking and a factor which lowers the value of the product, and the stronger off-note is directed to 15 point.

Pungency during smoking: this means a feeling in that a sense of being pricked by a thorn, pungency or sting in an inside of a mouth, a neck and a nose is continued for more than one second, and a sense in that sudden intensity is felt and then slowly faded out. The stronger pungency is directed to 15 point.

Harmony during smoking: this means a degree of harmony between added flavor and generated smoke, and a degree that the flavor is not separated and is not too much nor insufficient. The superior harmony and balance is directed to 15 point.

Total taste quality of the cigarette during smoking: this means properties of body of smoke, richness, thickness and harmony in taste of the smoke and an intensity of taste of the cigarette which is felt not individually but totally. The larger intensity is directed to 15 point.

The results of the smoking sensory test by the special sensory test personnel are shown in FIG. 4. As the result of the smoking sensory test, there were no meaningful differences among the samples in all of the tested items. Therefore, the analysis showed that there would be no large difference in the original taste of the cigarette between the cigarette coated with the coating material for Low Ignition Propensity (LIP) of the present invention and the cigarette manufactured using sodium alginate used in the conventional fire-safe cigarette.

### Experimental Example 5

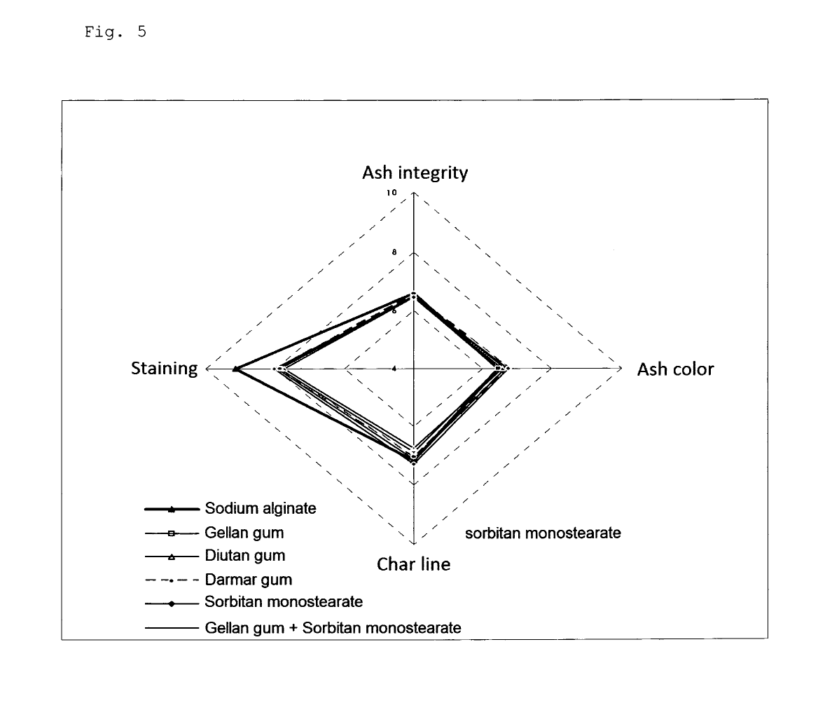

To compare and evaluate shapes of ash generated during smoking with respect to the cigarettes manufactured in Example 1 to 4 and Comparative Example 1, a sensory test for ash integrity was performed on 4 items (ash integrity, ash color, char line and staining) with 15 point scale by 25 special sensory test personnel and Quantitative descriptive analysis (paired t-test) was then performed. The results are shown in FIG. 5.

The test was repeated 5 times on the test items after naturally burning the cigarettes and closely photographing the remained ashes with a digital camera.

Detailed description on the test items is as follows.

Ash integrity: this is phenomenon of dispersion, surface crack, tattering and so on while ash remained after burn of the cigarette is conglomerated or hardened, and the severer degree is directed to 15 point.

Ash color: the ash color after burn is generally shown in white, gray and black, and the blacker is directed to 15 point.

Char line: the cigarette paper also burns with the burn of the cigarette and at this time the more crooked char line or the severer one-way burn is directed to 15 point.

Staining: this means a degree of blackening of the cigarette paper inside the char line and the severer staining is directed to 15 point.

The results of the test for the ash integrity by the special sensory test personnel are shown in FIG. 5. In the ash integrity, the ash color and the char line among the items of the ash integrity test, there were no significant differences among the samples.

However, the staining was significantly worse in the cigarette containing the cigarette paper coated with sodium alginate of Comparative Example 1. Therefore, the analysis showed that, with the cigarette containing the cigarette paper coated with the coating material for LIP of the present invention, it is possible to improve the staining in the band portion which has been a trouble of the conventional fire-safe cigarette.

TABLE 1

| | | | Comparative | Comparative | Example | Example | Example | Example | Example |
|---|---|---|---|---|---|---|---|---|---|
| Items | | Unit | Example 1 | Example 2 | 1 | 2 | 3 | 4 | 5 |
| Tobacco | Blending | | T brand | Same as left | | | | | |
| leaf | Weight | mg/cig | 590 | | | | | | |
| Cig. | Porosity | cu | 60 | | | | | | |
| Paper | Flax | % | 100 | | | | | | |
| lip paper | No perforation | cu | 0 | | | | | | |
| Ventilat on | Filter | % | 0 | | | | | | |
| Pressure | Cose | mmH₂O | 137 | | | | | | |
| Drop | Open | mmH₂O | 90 | | | | | | |

TABLE 2

| | Number | PASS | | | FAIL |
|---|---|---|---|---|---|
| Compound | of tested | Extinguisment | Extinguishment | Natural | Complete |
| Name | pieces | on holder | on paper | Extinguishment | Burning |
| Comparative Example 1 | 20 | 0 Piece | 6 Pieces | 6 Pieces | 14 Pieces |
| (Sodium Alginate) | | (0%) | (30%) | (30%) | (70%) |
| Example 1 | 20 | 1 Piece | 11 Pieces | 12 Pieces | 8 Pieces |
| (Diutan gum) | | (5%) | (55%) | (60%) | (40%) |
| Example 2 | 20 | 1 Piece | 10 Pieces | 11 Pieces | 9 Pieces |
| (Gellan gum) | | (5%) | (50%) | (55%) | (45%) |
| Example 3 | 20 | 0 Piece | 11 Pieces | 11 Pieces | 9 Pieces |
| (Sorbitan monostearate) | | (0%) | (55%) | (55%) | (45%) |
| Example 4 | 20 | 0 Piece | 9 Pieces | 9 Pieces | 11 Pieces |
| (Darmar gum) | | (0%) | (45%) | (45%) | (55%) |
| Example 5 | 20 | 0 Piece | 11 Pieces | 11 Pieces | 9 Pieces |
| (Mix: Gellan gum + | | (0%) | (55%) | (55%) | (45%) |
| Sorbitan monostearate) | | | | | |

### INDUSTRIAL APPLICABILITY

As described above, the cigarette containing the cigarette paper coated with the coating material for Low Ignition Propensity (LIP) shows a superior effect in the burning intensity test as compared to the conventional fire-safe cigarette applied with sodium alginate and can improve the staining in the band portion which has been a trouble of the conventional fire-safe cigarette.

Further, the cigarette containing the cigarette paper coated with sorbitan monostearate, darmer gum or gellan gum which shows a similar pyrolysis pattern to the conventional cigarette paper has no difference in the taste as compared to conventional cigarette, and thus the cigarette containing the coating material for Low Ignition Propensity (LIP) can be usefully used as a fire-safe cigarette.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A cigarette paper coated with a coating material for Low Ignition Propensity (LIP), the coating material for Low Ignition Propensity (LIP) containing at least one selected from the group consisting of diutan gum, darmar gum, gellan gum, sorbitan monostearate, sorbitan isosterate, propylene glycol stearate, glyceryl stearate, stearyl alcohol and Alpha-tocopheryl acetate.

2. The cigarette paper coated with a free coating material for Low Ignition Propensity (LIP) of claim 1, wherein the free coating material for LIP contains at least one selected from the group consisting of darmar gum, gellan gum and sorbitan monostearate.

3. The cigarette paper coated with a coating material for Low Ignition Propensity (LIP) of claim 2, wherein the coating material for LIP is coated on an outside, an inside or both sides of the cigarette paper.

4. The cigarette paper coated with a coating material for Low Ignition Propensity (LIP) of claim 3, wherein the coating material for LIP is formed in a form of a band on the cigarette paper.

5. The cigarette paper coated with a coating material for Low Ignition Propensity (LIP) of claim 4, wherein the coating material for LIP is in the form of the band with a width of 4˜20 mm, and a plurality of the bands are spaced apart from each other by a spacing of 4˜40 mm.

6. The cigarette paper coated with a coating material for Low Ignition Propensity (LIP) of claim 5, wherein the coating material for LIP has a thickness of 0.5˜20 μm.

7. The cigarette paper coated with a coating material for Low Ignition Propensity (LIP) of claim 1, wherein the coating material for LIP is coated by 0.001˜1 g per unit area (cm²).

8. A fire-safe cigarette, comprising the cigarette paper coated with a coating material for Low Ignition Propensity (LIP) of claim 1.

9. A fire-safe cigarette, comprising the cigarette paper coated with a coating material for Low Ignition Propensity (LIP) of claim 2.

10. A fire-safe cigarette, comprising the cigarette paper coated with a coating material for Low Ignition Propensity (LIP) of claim 3.

11. A fire-safe cigarette, comprising the cigarette paper coated with a coating material for Low Ignition Propensity (LIP) of claim 4.

12. A fire-safe cigarette, comprising the cigarette paper coated with a coating material for Low Ignition Propensity (LIP) of claim 5.

13. A fire-safe cigarette, comprising the cigarette paper coated with a coating material for Low Ignition Propensity (LIP) of claim 6.

14. A fire-safe cigarette, comprising the cigarette paper coated with a coating material for Low Ignition Propensity (LIP) of claim 7.
